(19) United States
(12) Patent Application Publication
(10) Pub. No.: US 2007/0062372 A1
(43) Pub. Date: Mar. 22, 2007

(54) Method of producing a mixture of ozone and high pressure carbon dioxide

(76) Inventor: Ravi Jain, Bridgewater, NJ (US)

Correspondence Address: THE BOC GROUP, INC., 575 MOUNTAIN AVENUE, MURRAY HILL, NJ, 07974-2064, US

(21) Appl. No.: 11/230,597

(22) Filed: Sep. 20, 2005

(51) Int. Cl. B01D 53/02

(52) U.S. Cl. 95/148

(57) ABSTRACT

Mixtures of an oxidizer and a high pressure fluid are produced by adsorbing an oxidizer in an adsorption bed and then desorbing the oxidizer with a high pressure fluid. The same steps can simultaneously occur in a second adsorbing bed but in reverse order. The oxidizer may be ozone and the high pressure fluid may be high pressure C0₂ including supercritical C0₂. Such mixtures can be used for applications such as cleaning semiconductor wafers, food disinfection and water disinfection.

### TECHNICAL FIELD

This invention relates generally to method and apparatus for producing a mixture of an oxidizer and a high pressure fluid useful for cleaning objects such as integrated circuit wafers and for disinfecting food or water and particularly to method and apparatus for producing a mixture of ozone and supercritical or high pressure carbon dioxide (SCCO₂ or HPCO₂) useful for cleaning objects and for disinfecting food or water.

### BACKGROUND OF THE INVENTION

Cleaning objects prior to performing work on them is an essential step in many manufacturing processes. One manufacturing process will be discussed in detail. For example, semiconductor integrated circuit manufacture has many steps in which a pattern is transferred from a mask to a substrate. The pattern is typically transferred by selective exposure of the substrate to radiation through a mask. The substrate is coated with a radiation sensitive material, termed a resist, whose solubility when exposed to an appropriate developer is altered by the radiation. After selected portions of the resist are removed, the now exposed portions of the substrate are modified by, for example, ion implantation, etching as well as other processes. After the modification is complete, the resist is removed and the process repeated until integrated circuit fabrication is complete.

As can be readily appreciated, the pattern must be accurately transferred from the mask to the substrate and this requires complete removal of the resist, as well as any unwanted material remaining from the process step, before the resist for the next process step is deposited and covers the substrate. Resists have typically been removed, that is, stripped, by either a wet technique, such as a HF rinse or a dry technique such as ashing. The latter technique essentially burns off the resist in an oxygen plasma. Although adequate for many purposes, these techniques have been found to possess drawbacks now that device dimensions are in the submicron regime. There are at least two potential problems. First, there may be unwanted debris remaining with dimensions comparable to device dimensions. Second, resist removal may be incomplete. It has been found that some process steps, for example, dry etching, may harden a portion of the resist and render it impervious to conventional stripping techniques. Accordingly, techniques other than the wet and dry techniques previously mentioned have been examined to determine their suitability for use in integrated circuit manufacture.

Another cleaning technique uses supercritical fluids as a solvent for unwanted particles. A supercritical fluid is a material that is above both its critical temperature, T_{c}, and critical pressure, P_{c}. These values define the highest temperature and highest pressure at which the vapor and liquid phases of the material can exist in equilibrium and thus define the critical point. The critical point can be understood by considering what happens physically along the line separating the liquid and vapor phases as both pressure and temperature are increased. The gas density increases and the liquid density decreases due to thermal expansion. When the two densities are equal, a supercritical fluid is present. Both temperature and pressure may be further increased from the critical point with the material remaining a supercritical fluid.

One supercritical fluid that has been examined for cleaning processes is supercritical carbon dioxide (SCCO₂). This material is attractive for use as a cleaning agent because it has a solubility comparable to those of light hydrocarbons without their environmental problems, and it has a relatively low surface tension. The latter attribute facilitates cleaning of small dimension features, such as holes in a semiconductor substrate, because the SCCO₂ can enter and clean the hole more easily than can high surface tension fluids.

The literature describing the use of SCCO₂ for cleaning is now extensive. For example, U.S. Pat. No. 6,602,349 describes the use of SCCO₂, with or without additives including solvents and surfactants, in cleaning semiconductor wafers to remove photoresist. U.S. Pat. No. 6,602,351 also teaches the use of SCCO₂ together with a solvent or surfactant for cleaning semiconductor surfaces. In addition to semiconductor integrated circuit wafers, mention is made of cleaning other devices such as micro-electro-mechanical and opto-electronic devices.

A further cleaning technique uses ozone, a strong oxidizing agent, to remove unwanted resist. The use of ozone for cleaning semiconductor wafers is described in United States Patent Application Publication 2002/0157686, wherein a layer of heated liquid, for example, water or HF, covers the wafer, then ozone is provided and diffuses through the liquid. The ozone reacts with unwanted material, such as photoresist, and thus facilitates its removal.

U.S. Pat. No. 5,507,957 describes another use of ozone, namely, the treatment of fluids. Disinfecting water or food, for example, juice, may be considered to be a type of cleaning as unwanted entities are removed or rendered harmless. For example, enzymes, which cause spoilage, are destroyed. As a pure or purer product results, this process may also be thought of as a manufacturing or cleaning process. In the treatment described, ozone containing oxygen is passed through a first adsorbing bed which preferentially adsorbs ozone. The nonadsorbed oxygen rich gas and air are passed through a second adsorbing bed which preferentially adsorbs nitrogen. Subsequently, the adsorbed ozone and nitrogen are desorbed and the combined stream then contacts the material being treated.

U.S. Pat. No. 6,242,165 describes a method for cleaning organic material from semiconductor wafers using an oxidizer in a supercritical state. Oxidizers include supercritical SO₃, supercritical H₂O₂, supercritical O₂, and supercritical O₃. The cleaning composition optionally includes supercritical components such as CO₂ or inert gases that are mixed in a mixing manifold.

While it is desirable to mix ozone from an ozone generator, the ozone being at a low pressure, with a fluid such as SCCO₂, which is at high pressure, such mixing of fluids at different pressures is generally difficult and additional apparatus and methods for forming a mixture of SCCO₂ and ozone are desirable.

### SUMMARY OF THE INVENTION

One embodiment of the present invention relates to an apparatus comprising an adsorption bed, an oxidizer source connected to the adsorption bed wherein the oxidizer is at a first pressure, a high pressure fluid source connected to the adsorption bed wherein the high pressure fluid is at a second pressure, the second pressure being greater than the first pressure, a depleted oxidizer outlet, and a fluid mixture outlet comprising a mixture of oxidizer and high pressure fluid.

According to another embodiment of the present invention, the apparatus includes a first and a second adsorption bed, an oxidizer source connected to the adsorption beds wherein the oxidizer is at a first pressure, a high pressure fluid source connected to the adsorption beds wherein the high pressure fluid is at a second pressure, the second pressure being greater than the first pressure, a depleted oxidizer outlet connected to the adsorption beds, and a fluid outlet comprising a mixture of oxidizer and high pressure fluid.

One method according to the present invention comprises adsorbing an oxidizer in an adsorption bed, desorbing the oxidizer by adsorbing a high pressure fluid in the adsorption bed, producing an outlet fluid mixture of oxidizer and high pressure fluid, and directing the outlet fluid mixture to a device.

### BRIEF DESCRIPTION OF THE DRAWING

FIG. 1 is a schematic representation of one embodiment of an apparatus according to the present invention for cleaning objects.

FIG. 2 is a schematic representation of a further embodiment of an apparatus according to the present invention for preparing a mixture of oxidizer and high pressure fluid.

FIG. 3 is a schematic representation of another embodiment of an apparatus according to the present invention for preparing a mixture of oxidizer and high pressure fluid using parallel adsorption beds.

### DETAILED DESCRIPTION

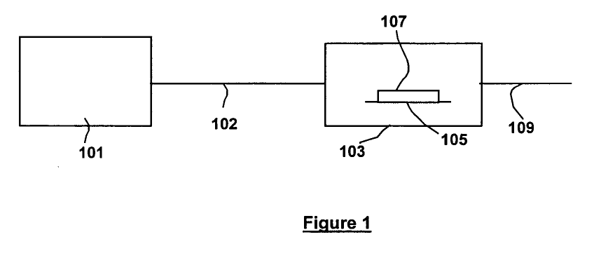

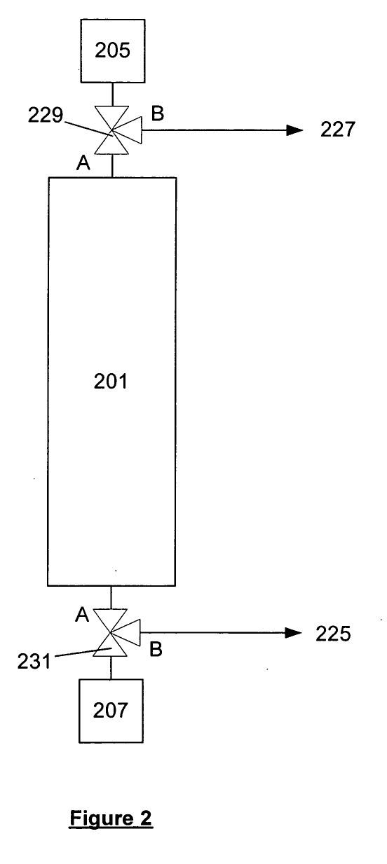

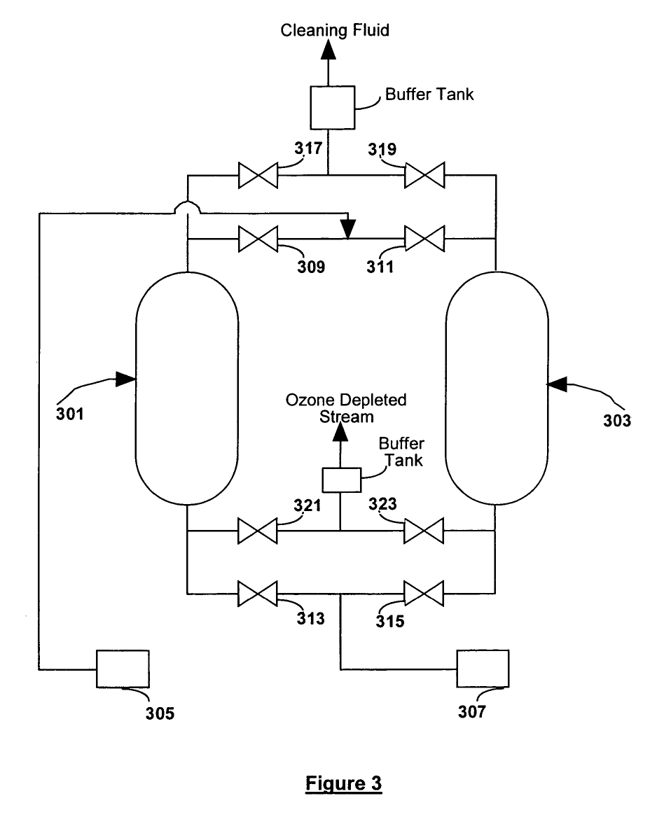

FIG. 1 is a schematic representation of one embodiment of an apparatus according to the present invention for producing a mixture of oxidizer and high pressure fluid in a batch system. Depicted are fluid mixture source 101, cleaning chamber 103, and fluid outlet 109. Line 102 connects fluid mixture source 101 and cleaning chamber 103. “Line” is used to mean a pipe or other structure capable of conveying fluids. In a typical embodiment for cleaning of semiconductor wafers, cleaning chamber 103 is a single wafer post etch chamber. Within cleaning chamber 103 are substrate support 105 which supports the wafer 107 that is to be cleaned. Standard elements of the apparatus are not depicted for reasons of clarity. For example, fluid outlet 109 may go to a recycle apparatus that removes solvents and debris from the fluid and then recycles the fluid to fluid mixture source 101. Further, the cleaning chamber 103, fluid outlet 109 and line 102 represent standard components known in the industry. Fluid mixture source 101 will be described in more detail with respect to FIG. 2 and FIG. 3.

FIG. 2 is a schematic representation of one embodiment of a fluid mixture source according to the present invention. Depicted are adsorbing bed 201 containing an adsorbent, oxidizer source 205, and high pressure fluid source 207. The system of the present invention may include standard components such as valves and other flow control devices, such as flow controllers, to control the flow of oxidizer and high pressure fluid into adsorption bed 201. As shown in FIG. 2, during operation, oxidizer flows from the oxidizer source 205 through port A of a three-way valve 229 and into the adsorption bed 201, adsorbing onto an adsorbent. Depleted oxidizer flows through port B of a three-way valve 231 and through oxidizer outlet 225. High pressure fluid flows from high pressure fluid source 207 through port A of three-way valve 231 and into adsorption bed 201. The high pressure fluid adsorbs onto the adsorbent thereby desorbing the previously adsorbed oxidizer. This results in a mixture of high pressure fluid and oxidizer which then flows through port B of three-way valve 229 and exits the system through fluid mixture outlet 227.

The depleted oxidizer flowing through oxidizer outlet 225 may be recycled through a recycle system or exhausted to an exhaust waste treatment system. The high pressure fluid and oxidizer mixture flowing through fluid mixture outlet 227 may flow directly to a device or tool, such as cleaning chamber 103 shown in FIG. 1, or may be sent to a storage vessel for later use.

The operation of the apparatus shown in FIG. 2 can be described in greater detail as follows. Adsorption bed 201 first receives an oxidizer, such as ozone, from an oxidizer source 205, such as an ozone generator. The oxidizer adsorbs onto the adsorbent, and a stream of depleted oxidizer flows through oxidizer outlet 225 and to a recycle or exhaust system (not shown). An oxidizer sensor (not shown) may be associated with the oxidizer outlet 225 to monitor the concentration of oxidizer exiting the adsorption bed 201. Alternatively the oxidizer sensor may be associated with the ozone generator operating at low power, which reduces operating costs.

When the oxidizer concentration, as measured by the oxidizer sensor, reaches a predetermined setpoint, oxidizer flow through the adsorption bed 201 will stop and a high pressure fluid from high pressure fluid source 207, such as supercritical carbon dioxide, will begin to flow through adsorption bed 201. The high pressure fluid adsorbs onto the adsorbent thereby displacing the previously adsorbed oxidizer. This in turn, creates a mixture of the oxidizer and high pressure fluid that flows through fluid mixture outlet 227 and to a device such as a semiconductor processing chamber or a storage vessel.

A further sensor may be associated with the fluid mixture outlet 227 and connected to a programmable logic controller (PLC) to monitor the oxidizer concentration in the fluid mixture. In addition, a flow controller for controlling the flow rate of high pressure fluid into the adsorption bed 201 may be fluidly connected to high pressure fluid source 207 and electrically connected to the PLC. The operation of the apparatus in this configuration would enable monitoring of the oxidizer concentration in fluid mixture outlet 227 with the sensor and providing a signal indicative of oxidizer concentration in the fluid mixture to the PLC. The PLC would then send a signal to the flow controller to adjust the high pressure fluid flow rate based upon a predetermined setpoint for the desired oxidizer concentration in the fluid mixture exiting from the fluid mixture outlet 227.

As an optional step, following desorption of oxidizer, the bed is vented to the atmosphere, and high pressure fluid in the void space and any remaining in the adsorption bed 201 is removed by flowing a purge gas, such as oxygen, through the adsorption bed 201. The oxidizer adsorption, desorption with high pressure fluid and high pressure fluid removal steps are repeated cyclically until cleaning is complete. The process as described with respect to FIG. 2 is a batch process because during the ozone adsorption and high pressure fluid removal steps, the system does not produce a fluid mixture of oxidizer and high pressure fluid.

In another embodiment of the present invention, shown in FIG. 3, the fluid mixture is produced in a continuous manner. Referring to FIG. 3, the system of the present invention includes adsorption beds 301 and 303, and fluid sources 305 and 307. Further shown is one possible valving system, wherein input valves 309 and 311 are used to direct oxidizer from source 305 to either adsorption bed 301 or 303, respectively and valves 313 and 315 are used to direct the high pressure fluid from source 307 to either adsorption bed 301 or 303, respectively. Valves 317 and 319 are used to control the high pressure fluid output from adsorption beds 301 and 303, respectively, and valves 321 and 323 are used to control the output of the depleted oxidizer from adsorption beds 301 and 303, respectively. In an alternative arrangement, any one of the two-way valve pairs 309 and 311, 313 and 315, 321 and 323, or 317 and 319 can be replaced with three-way valves.

The operation of the apparatus shown in FIG. 3 will now be described in detail. At any time, one adsorption bed will adsorb the oxidizer while the other bed is purged of first the oxidizer and then of excess high pressure fluid. The oxidizer desorption is accomplished by passing the high pressure fluid through the adsorption bed containing the oxidizer. Following oxidizer desorption, the bed is optionally vented to the atmosphere and high pressure fluid in the void space and any high pressure fluid in the adsorption bed is removed by flowing a purge gas, such as oxygen, through the adsorption bed. The oxidizer adsorption, desorption with high pressure fluid and purge steps are repeated cyclically in both beds until cleaning is complete. The process described with respect to FIG. 3 is a continuous process because one bed is adsorbing while the other bed is desorbing and the system operates continuously in creating the output fluid mixture.

The cycle time for the dual adsorption bed process is preferably in the range between 2 and 20 minutes. For example, time periods for the various steps according to one embodiment of the present invention are summarized in the following table.

| Bed 301 | Bed 303 | Time (minutes) |
|---|---|---|
| Pressurization | Oxidizer adsorption | 0.25 |
| Oxidizer adsorption | CO2 purge | 4.00 |
| Oxidizer adsorption | Depressurization | 0.25 |
| Oxidizer adsorption | Purge for CO2 removal | 0.50 |
| Oxidizer adsorption | Pressurization | 0.25 |
| CO₂ purge | Oxidizer adsorption | 4.00 |
| Depressurization | Oxidizer adsorption | 0.25 |
| Purge for CO₂ removal | Oxidizer adsorption | 0.50 |

The cycles may be operated continuously with the appropriate valves being opened and closed as steps begin and stop during the cycle, as is known in the art.

There are several alternatives available for valve control systems for operating the apparatus and performing the methods of the present invention. For example, valves may be controlled with a computer, mechanically or even manually. Further, different valves may be controlled in different manners.

The oxidizer source for the system of the present invention can be an ozone generator, which produces a mixture of oxygen and ozone (O₂ and O₃) by partially converting a stream of oxygen into the ozone. The appropriate amount of conversion is set according to the desired outcome, and the highest ozone concentration is not always used because higher concentrations require more power to generate and thus have a higher cost. A practical maximum concentration is 20 percent O₃. An oxygen rich feed gas for producing the oxidizer, such as ozone, may be produced from a pressure swing adsorption (PSA) facility. While ozone is the preferred oxidizer, other oxidizers may be used, such as hydrogen peroxide (H₂O₂) or nitrogen trifluoride (NF₃).

The high pressure fluid is typically chosen based on the material being cleaned. For semiconductor cleaning, SCCO₂ is usually preferred, while for disinfecting food products such as juice or drinking water, high pressure CO₂ including SCCO₂ may be used. The high pressure fluid may optionally contain co-solvents such as alcohols or disinfectants. The high pressure fluids and their generation are well known in the art.

Suitable adsorbents for the adsorption beds include silica gel, high silica mordenites and other materials that do not destroy ozone to a significant extent during adsorption. The appropriate adsorbents for the adsorption beds may be chosen by the operator based on the high pressure fluid and oxidizer used.

The operating parameters for the system according to the present invention can be readily set by the operator skilled in the art. For example, the adsorption beds are sized to adsorb the desired amount of fluid. A useful range for oxidizer adsorption pressures is from 5 psig to 50 psig (pounds per square inch gauge) because it approximately matches the pressure of the ozone/oxygen mixture from oxidizer. The desorption pressure using high pressure fluid is preferably in the range of 50 psia to 4000 psia (pounds per square inch absolute). In a more particular example, when treating water, the pressure range is typically between 50 psia and 200 psia. When using ozone as the oxidizer, the ozone concentration may be varied between 6 percent and 20 percent and the flow rate of the high pressure fluid may also be varied.

There are several alternatives that may improve the cycle times. For example, the purge gas may be used at the same temperature as the oxidizer feed, however, a slightly higher temperature, for example, 10 to 30 degrees C. higher than the feed temperature, for the purge gas during part of the purge may reduce the amount of purge gas needed. Standard heaters may be used to heat the purge gas. Additionally, an ozone compatible vacuum pump, for example, a dry vacuum or a water ring vacuum, may be used to reduce the amount of purge gas required during the purge operation.

While FIG. 1 shows a semiconductor wafer being cleaned, it has previously been noted that the system of the present invention can be used to disinfect food or to clean water. In such systems, supercritical a high pressure CO₂ destroys enzymes that cause food to spoil. For water disinfection, ozone destroys microorganisms in water while CO₂ lowers the pH of water thereby suppressing the formation of unwanted disinfection byproducts.

Moreover, while it is understood that the term oxidizer includes such standard oxidizers as ozone, hydrogen peroxide, and nitrogen trifluoride, in food and water disinfecting applications where ozone is used, the ozone may react with enzymes or microorganisms by mechanisms other than oxidation. Hence, the term oxidizer is here defined to embrace ozone when employed in food and water disinfecting applications.

Other variations in the apparatus and operation are contemplated. For example, more than two adsorption beds may be used. Moreover, as noted above, additional solvents or disinfectants may be added to the high pressure fluid.

It is anticipated that other embodiments and variations of the present invention will become readily apparent to the skilled artisan in the light of the foregoing description and examples, and it is intended that such embodiments and variations likewise be included within the scope of the invention as set out in the following claims.

What is claimed is:

1. An apparatus for producing a fluid mixture comprising:
an adsorption bed;
an oxidizer source connected to the adsorption bed wherein the oxidizer is at a first pressure;
a high pressure fluid source connected to the adsorption bed wherein the high pressure fluid is at a second pressure, the second pressure being greater than the first pressure;
a depleted oxidizer outlet connected to said adsorption bed; and
a fluid mixture outlet connected to said adsorption bed.

2. The apparatus of claim 1 wherein the high pressure fluid is high pressure carbon dioxide.

3. The apparatus of claim 1 wherein the high pressure carbon dioxide is supercritical carbon dioxide.

4. The apparatus of claim 1 wherein the oxidizer is a mixture of oxygen and ozone.

5. The apparatus of claim 1 wherein the oxidizer is selected from hydrogen peroxide and nitrogen trifluoride.

6. The apparatus of claim 1 wherein the first pressure is from about 5 to about 50 psig.

7. The apparatus of claim 1 wherein the second pressure is from about 50 to about 4,000 psia.

8. The apparatus of claim 7 wherein the second pressure is from about 50 to about 200 psia.

9. The apparatus of claim 4 wherein the oxidizer source is an ozone generator.

10. The apparatus of claim 1 wherein an adsorbent in the adsorption bed comprises an ozone nondestructive material.

11. The apparatus of claim 10 wherein the ozone nondestructive material comprises at least one of silica gel and high silica mordenites.

12. The apparatus of claim 9 wherein a first sensor is connected to the depleted oxidizer outlet and the first sensor monitors ozone concentration in the depleted oxidizer outlet.

13. The apparatus of claim 12 wherein the first sensor is electrically connected to the ozone generator and wherein the ozone generator is operated at low power causing the ozone and oxygen mixture to flow into the adsorption bed until the ozone concentration as measured by the first sensor reaches a predetermined setpoint.

14. The apparatus of claim 1 wherein a flow controller is connected to the high pressure fluid source and the flow controller controls the flow rate of the high pressure fluid into the adsorption bed.

15. The apparatus of claim 14 wherein a second sensor is connected to the fluid outlet and the second sensor monitors oxidizer concentration in the oxidizer and high pressure fluid mixture.

16. The apparatus of claim 15 wherein the second sensor is electrically connected to the flow controller and wherein the second sensor sends a signal indicative of oxidizer concentration to the flow controller and the flow controller adjusts the flow rate of the high pressure fluid to maintain a predetermined oxidizer concentration in the fluid outlet.

17. The apparatus of claim 1 wherein the fluid mixture outlet is connected to a storage vessel.

18. The apparatus of claim 1 wherein the fluid mixture outlet is connected to a semiconductor chamber.

19. The apparatus of claim 1 wherein the fluid mixture outlet is connected to a food purification system.

20. The apparatus of claim 1 wherein the fluid mixture outlet is connected to a water purification system.

21. The apparatus of claim 1, further comprising:
a second adsorption bed;
wherein the oxidizer source is connected to the second adsorption bed and wherein the oxidizer is at the first pressure;
the high pressure fluid source is connected to the second adsorption bed and wherein the high pressure fluid is at the second pressure;
the depleted oxidizer outlet is connected to the second adsorption bed; and
the a fluid mixture outlet is connected to the second adsorption bed.

22. The apparatus of claim 21 wherein the adsorption beds are connected in a parallel configuration.

23. The apparatus of claim 21 wherein one of the adsorption beds produces the fluid mixture while the other adsorption bed regenerates.

24. An apparatus for producing a fluid mixture comprising:
an adsorption bed capable of adsorbing an oxidizer and high pressure carbon dioxide;
an oxidizer source connected to the adsorption bed;
a high pressure carbon dioxide source connected to the adsorption bed;
a depleted oxidizer outlet connected to the adsorption bed; and
a fluid mixture outlet connected to the adsorption bed.

25. An apparatus for producing an ozone and carbon dioxide mixture comprising:
an adsorption bed having an adsorbent;
an ozone source connected to the adsorption bed wherein ozone flows through the adsorption bed and adsorbs onto an adsorbent;
a depleted ozone outlet connected to the adsorption bed;
a high pressure carbon dioxide source connected to the adsorption bed wherein the high pressure carbon dioxide flows through the adsorption bed and desorbs the adsorbed ozone; and
a fluid mixture outlet connected to the adsorption bed.

26. A method of producing a fluid mixture comprising the steps of:
passing an oxidizer through an adsorption bed and adsorbing the oxidizer onto an adsorbent;
desorbing the oxidizer by passing a high pressure fluid through the adsorption bed; and
producing a mixture of oxidizer and high pressure fluid.

27. The method of claim 26 wherein the oxidizer is a mixture of oxygen and ozone.

28. The method of claim 26 wherein the oxidizer is selected from hydrogen peroxide and nitrogen trifluoride.

29. The method of claim 27 further comprising the step of producing the mixture of oxygen and ozone by an ozone generator.

30. The method of claim 26 wherein the high pressure fluid is high pressure carbon dioxide.

31. The method of claim 26 wherein the high pressure carbon dioxide is supercritical carbon dioxide.

32. The method of claim 26 further comprising the step of directing the mixture to a device.

33. The method of claim 32 wherein the device is a semiconductor chamber.

34. The method of claim 32 wherein the device is a storage vessel.

35. The method of claim 32 wherein the device is a food processing system.

36. The method of claim 32 wherein the device is a water purification system.

37. The apparatus of claim 26 wherein the adsorbent comprises an ozone nondestructive material.

38. The apparatus of claim 37 wherein the ozone nondestructive material comprises at least one of silica gel and high silica mordenites.

39. A method for producing a fluid mixture comprising the steps of:
adsorbing an oxidizer in a first adsorption bed;
desorbing the oxidizer by passing a high pressure fluid through the first adsorption bed to produce a first fluid mixture of oxidizer and high pressure fluid;
adsorbing an oxidizer in a second adsorption bed; and
desorbing the oxidizer by passing a high pressure fluid through the second adsorption bed to produce a second fluid mixture of oxidizer and high pressure fluid.

40. The method of claim 39 wherein the oxidizer is a mixture of oxygen and ozone.

41. The method of claim 40 further comprising the step of producing the mixture of oxygen and ozone by an ozone generator.

42. The method of claim 39 wherein the high pressure fluid is a high pressure carbon dioxide.

43. The method of claim 42 wherein the high pressure carbon dioxide is a supercritical carbon dioxide.

44. The method of claim 39 wherein the step of adsorbing in the first adsorption bed is performed while the step of desorbing in the second adsorption bed is occurring and the step of adsorbing in the second adsorption bed is performed while the step of desorbing in the first adsorption bed is occurring.

45. The method of claim 39 further comprising the step of directing at least one of the first fluid mixture and the second fluid mixture to a device.

46. The method of claim 45 wherein the device is a semiconductor processing chamber.

47. The method of claim 45 wherein the device is a storage vessel.

48. The method of claim 45 wherein the device is a food processing system.

49. The method of claim 45 wherein the device is a water purification system.

50. The method of claim 39 wherein the pressure of the high pressure fluid is greater than the pressure of the oxidizer.
